(19) United States
(12) Patent Application Publication
(10) Pub. No.: US 2024/0356400 A1
(43) Pub. Date: Oct. 24, 2024

(54) BRUSHLESS MOTOR AND ROTOR THEREOF

(71) Applicant: SHENZHEN TOPBAND CO., LTD., Shenzhen (CN)

(72) Inventor: Xingwei WANG, Shenzhen (CN)

(73) Assignee: SHENZHEN TOPBAND CO., LTD., Shenzhen, GD (CN)

(21) Appl. No.: 18/710,188

(22) PCT Filed: Jun. 1, 2022
(86) PCT No.: PCT/CN2022/096660

§ 371 Date: May 15, 2024

(30) Foreign Application Priority Data
Nov. 16, 2021 (CN) 202111355209.6

(51) Int. Cl. H02K 1/2791

(52) U.S. Cl. CPC H02K 1/2791

(57) ABSTRACT

The application relates a brushless motor and a rotor thereof. The rotor of the brushless motor comprises a rotor core, multiple first magnets for generating first magnetic fields in a radial direction of the rotor core, and multiple second magnets for generating second magnetic fields in a tangential direction of the rotor core; and the multiple first magnets and the multiple second magnets are alternately arranged one by one in a circumferential direction of the rotor core, so that the first magnetic fields and the second magnetic fields are mixed to form a hybrid magnetic field. The rotor can reduce electromagnetic noise of the motor and provides a counter electromotive force with better sinusoidal degree, which can satisfy requirements of FOC drive, reduce the cost of the motor, improve the performance of the motor, and reduce the weight of the motor.

### TECHNICAL FIELD

The application relates to motors, and more particularly, relates to a brushless motor and a rotor thereof.

### BACKGROUND

Magnets of rotors of brushless motors in the related art usually generate only a magnetic field in a radial direction or a magnetic field in a tangential direction, The magnetic field distributions are shown in FIG. 1 and FIG. 2, and the magnetic field distribution at the end in the presence of the magnetic field in the radial direction only is shown in FIG. 3.

### SUMMARY OF THE INVENTION

### Technical Problem

Normally, such brushless motors generally have the defects of electromagnetic noise and poor counter electromotive force, which are unable to satisfy the requirements of FOC (field-oriented control) drive, and have a high manufacturing cost.

### Solution to the Problem

### Technical Solution

The technical problem to be solved by the application is to provide an improved brushless motor and a rotor thereof.

The technical solution the application adopts to solve the technical problem is to construct a rotor of a brushless motor, which includes a rotor core, multiple first magnets for generating first magnetic fields in a radial direction of the rotor core, and multiple second magnets for generating second magnetic fields in a tangential direction of the rotor core. The multiple first magnets and the multiple second magnets are alternately arranged one by one in a circumferential direction of the rotor core so that the first magnetic fields and the second magnetic fields are mixed to form a hybrid magnetic field.

Preferably, the first magnets and the second magnets are all bar shaped magnets.

Each of the first magnets has a first width direction and a first thickness direction perpendicular to the first width direction; the first width direction is perpendicular to the radial direction of the rotor core, and the first thickness direction is perpendicular to the tangential direction of the rotor core.

Each of the second magnets has a second width direction and a second thickness direction perpendicular to the second width direction.

The second width direction is perpendicular to the tangential direction of the rotor core, and the second thickens direction is perpendicular to the tangential direction of the rotor core.

Preferably, the rotor core is configured as a hollow structure with a hollow space extending through two ends of the rotor core.

Multiple first limiting slots in one-to-one correspondence with the multiple first magnets are formed in an inner wall surface of the rotor core.

Preferably, multiple second limiting slots in one-to-one correspondence with the multiple second magnets are formed in the inner wall surface of the rotor core.

The multiple first limiting slots and the multiple second limiting slots are alternately arranged one by one in the circumferential direction of the rotor core.

Preferably, a housing is further provided to be sleeved around an outside of the rotor core.

Preferably, positioning structures are arranged on the housing and the rotor core.

The positioning structures comprise a bulge arranged on an outer wall surface of the rotor core and protruding in the radial direction, and a positioning groove formed in an inner wall surface of the housing and corresponding to the bulge.

Preferably, a rotary shaft is further provided, with two ends of the rotary shaft extending out of the rotor core.

The housing includes a body, an opening formed at one end of the body to allow for insertion of the rotor core into the body, and a through hole formed in the other end of the housing to allow the rotary shaft to extend out.

Preferably, an anti-slip sleeve is further provided, which is arranged in the through hole and sleeved around the rotary shaft.

Preferably, surfaces, facing each other, of two of the second magnets located on two opposite sides of each of the first magnet are identical in magnetic polarity.

Surfaces, facing the rotary shaft, of two of the first magnets located on two opposite sides of each of the second magnet are opposite in magnetic polarity.

The present application further provides a brushless motor, including the rotor of the present application, and a stator assembled with the rotor.

### Beneficial Effects of the Invention

### Beneficial Effects

Implementing the brushless motor and the rotor thereof of the application has the following beneficial effects: multiple first magnets capable of generating first magnetic fields in a radial direction of a rotor core of the rotor and multiple second magnets capable of generating second magnetic fields in a tangential direction of the rotor core are arranged on the rotor core, and the multiple first magnets and the multiple second magnets are alternately arranged one by one in a circumferential direction of the rotor core, so that the first magnetic fields and the second magnetic fields are mixed to form a hybrid magnetic field. The rotor can thus reduce electromagnetic noise of the motor, provide a counter electromotive force with better sinusoidal degree, satisfy the requirements of FOC drive, reduce the cost of the motor, improve the performance of the motor, and reduce the weight of the motor.

### BRIEF DESCRIPTION OF THE DRAWINGS

The application will be further described below in conjunction with accompanying drawings and embodiments. In the drawings,

FIG. 1 is a schematic diagram of the magnetic field distribution of an existing brushless motor only with a magnetic field in a radial direction;

FIG. 2 is a schematic diagram of the magnetic field distribution of an existing brushless motor only with a magnetic field in a tangential direction;

FIG. 3 is a schematic diagram of the magnetic field distribution at the end of the existing brushless motor only with a magnetic field in the radial direction;

FIG. 4 is a schematic structural diagram of a rotor of a brushless motor according to the application;

FIG. 5 is an exploded structural diagram of the rotor of the brushless motor shown in FIG. 4;

FIG. 6 is a schematic structural diagram illustrating the assembly of a rotor core and magnets of the rotor of the brushless motor shown in FIG. 4;

FIG. 7 is a schematic structural diagram of the rotor core of the rotor of the brushless motor shown in FIG. 4 assembled with a housing;

FIG. 8 is a schematic structural diagram of the rotor core of the brushless motor shown in FIG. 5;

FIG. 9 is a schematic structural diagram of a first magnet of the brushless motor shown in FIG. 5;

FIG. 10 is a schematic structural diagram of a second magnet of the brushless motor shown in FIG. 5;

FIG. 11 is a schematic structural diagram of the housing of the rotor of the brushless motor shown in FIG. 5;

FIG. 12 is a schematic diagram of the magnetic field distribution of the brushless motor shown in FIG. 4;

FIG. 13 is a schematic diagram showing the magnetic field distribution at the end of the brushless motor shown in FIG. 4; and

FIG. 14 is a schematic diagram showing a counter electromotive force of the brushless motor shown in FIG. 4.

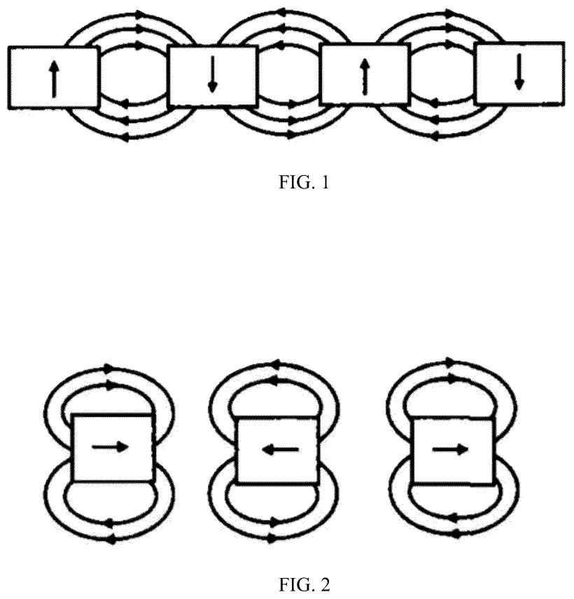

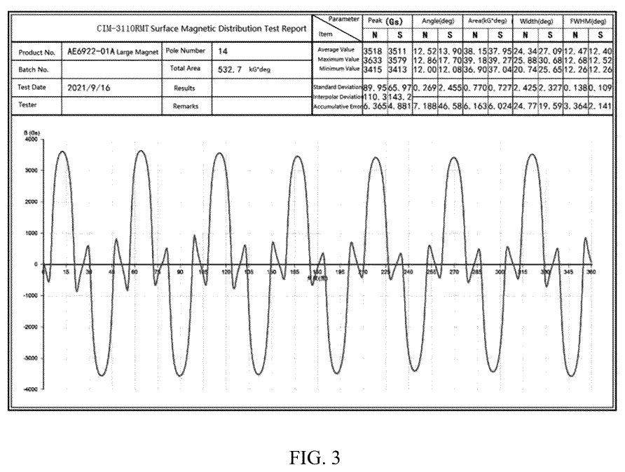

### PREFERRED EMBODIMENT FOR IMPLEMENTING THE INVENTION

### Preferred Embodiment of the Invention

To gain a better understanding of the technical features, purposes and effects of the application, specific embodiments of the application are described in detail herein with reference to accompanying drawings.

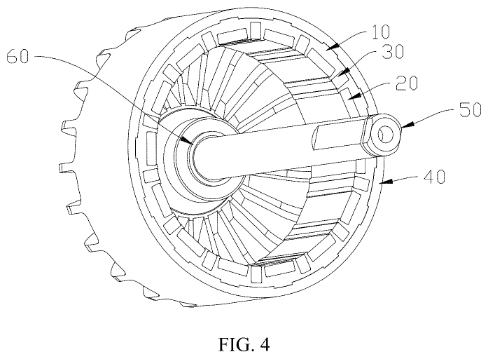

FIG. 4 illustrates some preferred embodiments of a brushless motor according to the application. The brushless motor has the advantages of low noise, good performance and light weight.

As shown in FIG. 4, in some embodiments, the brushless motor may include a rotor and a stator assembled with the rotor. The rotor may include a rotor core 10, a first magnet 20 and a second magnet 30. The rotor core 10 may be cylindrical in shape. There can be provided with multiple such first magnets 20 that are arranged at intervals in a circumferential direction of the rotor core 20, and each first magnet 20 may generate a first magnetic field in a radial direction of the rotor core 10. There can be provided with multiple such second magnets 30 that are arranged at intervals in the circumferential direction of the rotor core 10, and each second magnet 30 may generate a second magnetic field in a tangential direction of the rotor core 10. The first magnetic fields and the second magnetic fields may be mixed to form a hybrid magnetic field. By adopting the hybrid magnetic field, the magnetism gathering ability of the motor can be effectively improved; low-grade magnets can be used to obtain the performance of high-grade magnets, so the motor of the same power level has a lighter weight, higher efficiency and lower cost, and the electromagnetic noise of the brushless motor can be greatly lowered; and the present application can guarantee a lower cogging torque of the motor, reduce a torque ripple of the motor, and increase the NVH value of the motor, while reducing the weight of the motor, thereby improving the market competitiveness and expanding the application range of the motor, and hence bringing good economic benefit and social significance.

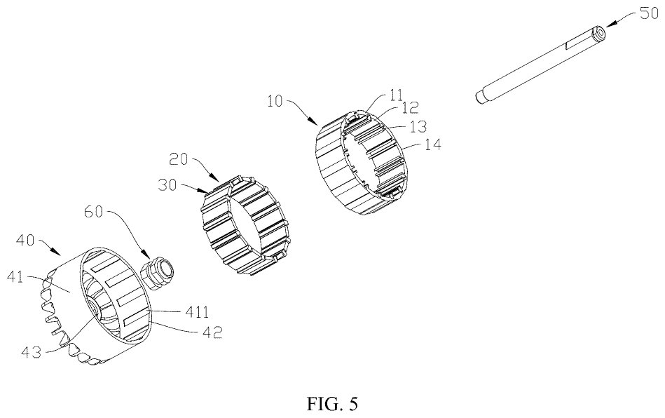

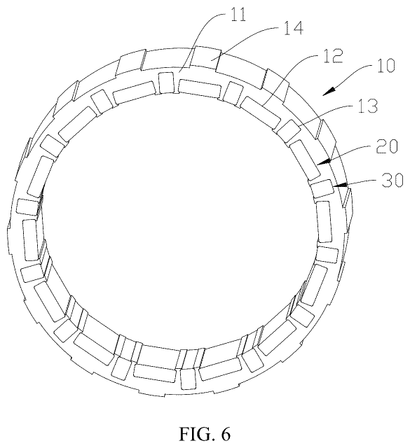

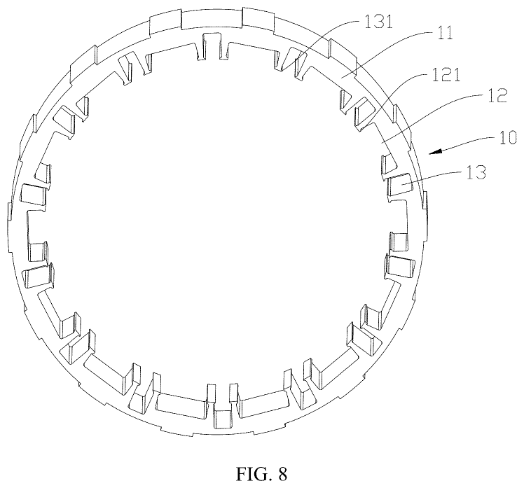

As shown in FIG. 5-FIG. 8, further, in some embodiments, the rotor core 10 is configured as a hollow structure with a hollow space extending through two ends of the rotor core 10, and may include a cylindrical body 11, a first limiting slot 12 and a second limiting slot 13. The cylindrical body 11 may be made from silicon steel sheets by stamping. Multiple inner teeth may be arranged at intervals on an inner side of the cylindrical body 11, with one first limiting slot 12 or one second limiting slot 13 formed between each two adjacent inner teeth. The first limiting slot 12 is used to limit the first magnet 20, and the second limiting slot 13 is used to limit the second magnet 30. By means of the first limiting slot 12 and the second limiting slot 13, the problem of falling of the magnet can be solved. The magnet is generally mounted on the surface of the rotor of the brushless motor or is inserted into the rotor, and particularly for external-rotor motors, most of which adopt the magnet mounted on the surface of the rotor and generally use a seamless tube as a magnetic yoke of the rotor to provide a magnetic field path, it can be difficult to bond the magnet on the rotor. The magnet often falls especially in harsh application scenarios, leading to a failure of the rotor. The first limiting slot 12 and the second limiting slot 13 can effectively solve this problem.

In some embodiments, there can be provided with multiple such first limiting slots 12, and the first limiting slots 12 are formed in an inner wall surface of the rotor core 10. Specifically, the first limiting slots 12 may be formed in an inner wall surface of the cylindrical body 11 and spaced apart from each other in the circumferential direction of the rotor core 10. The first limiting slots 12 may be in one-to-one correspondence with the first magnets 20 and used to limit the first magnets 20 to prevent the first magnets 20 from falling off. Specifically, the first limiting slots 12 may be bar shaped slots extending through two ends of the rotor core 10. A first slot opening is formed at a lateral end of each first limiting slot 12 to allow for the insertion of the corresponding first magnet 20 into the first limiting slot 12. A first limit flange 121 is arranged on each of two opposite sides of the first slot opening and extends toward each other to block the corresponding first magnet 20, thereby preventing the first magnet 20 from falling off in the radial direction. In some embodiments, magnet glue may be arranged between the first limiting slot 12 and the first magnet 20 to prevent the first magnet 20 from falling off in case of a high speed and large rotational inertia.

There can be provided with multiple such second limiting slots 13, and the second limiting slots 13 can be formed in the inner wall surface of the rotor core 10. Specifically, the second limiting slots 13 may be formed in the inner wall surface of the cylindrical body 11 and spaced apart from each other in the circumferential direction of the rotor core 10. The second limiting slots 13 and the first limiting slots 12 may be alternately arranged in the circumferential direction of the rotor core 10. The second limiting slots 13 may be in one-to-one correspondence with the second magnets 30 and used to limit the second magnets 30 to prevent the second magnets 30 from falling off. Specifically, in some embodiments, the second limiting slots 13 may be bar shaped slots extending through two ends of the rotor core 10. A second slot opening is formed at a lateral end of each second limiting slot 13 to allow for the insertion of the corresponding second magnet 30 into the second limiting slot 13. A second limit flange 131 is arranged on each of two opposite sides of the second slot opening and extends toward each other to block the corresponding second magnet 30, thereby preventing the second magnet 30 from falling off in the radial direction. In some embodiments, magnet glue is arranged between the second limiting slot 13 and the second magnet 30 to prevent the second magnet 30 from falling off in case of a high speed and large rotational inertia.

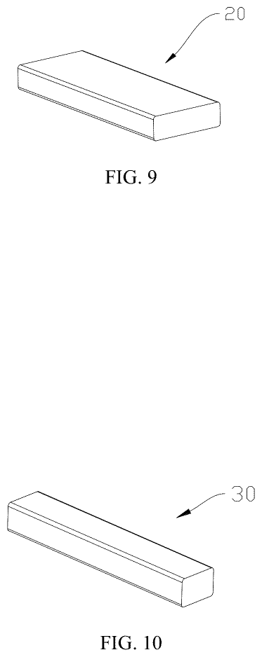

As shown in FIG. 9, further, in some embodiments, the first magnet 20 may be a bar shaped magnet. Specifically, the first magnet 20 may be rectangular or tile-shaped. The first magnet 20 may have a first width direction, a first thickness direction and a first length direction. When the first magnets 20 are assembled in the first limiting slots 12, the first width direction may be perpendicular to the radial direction of the rotor core 10, the first length direction may be parallel to an axial direction of the rotor core 10, and the first thickness direction may be perpendicular to the tangential direction of the rotor core 10. In some embodiments, surfaces, facing a rotary shaft 50, of two of the first magnets 20 located at two opposite sides of each of second magnets 20 are opposite in magnetic polarity.

As shown in FIG. 10, further, in some embodiments, the second magnet 30 may be a bar shaped magnet. Specifically, the second magnet 30 may be rectangular or tile-shaped. The width of the second magnet 30 may be less than the width of the first magnet 20. The second magnet 30 may have a second width direction, a second thickness direction and a second length direction. When the second magnets 30 are assembled in the second limiting slots 13, the second width direction may be perpendicular to the tangential direction of the rotor core 10, the second thickness direction may be perpendicular to the tangential direction of the rotor core 10, and the second length direction may be perpendicular to the axial direction of the rotor core 10. In some embodiments, surfaces, facing each other, of two of the second magnets 30 located at two opposite sides of each of the first magnets 20 are identical in magnetic polarity.

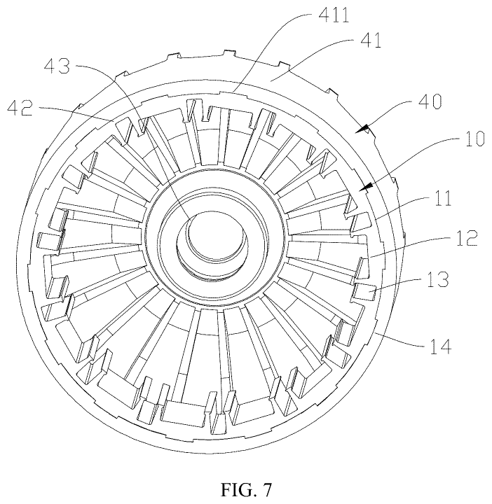

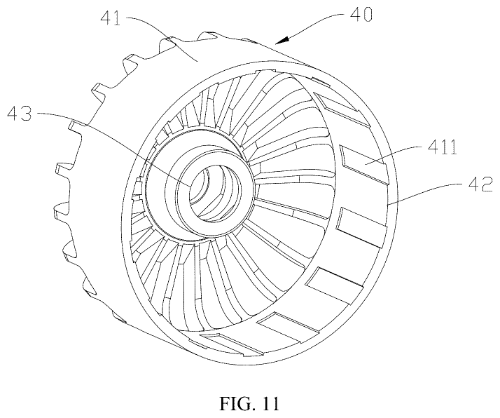

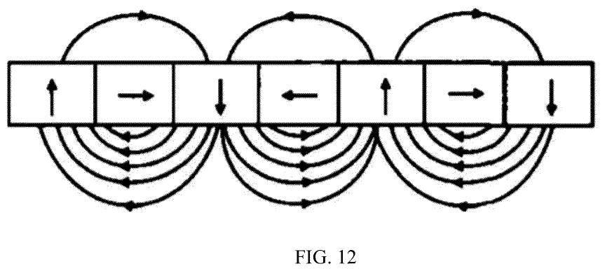

As shown in FIG. 7 and FIG. 11, further, in some embodiments, the rotor of the brushless motor may further include a housing 40. The housing 40 may be sleeved around an outside of the rotor core 10. The housing 40 may be made from a die-cast aluminium alloy, which can enclose the rotor core 10 and realize dynamic balance of the rotor by removal of material to improve the quality and production efficiency of the motor. In some embodiments, the housing 40 may include a body 41, an opening 42 and a through hole 43. The body 41 may be cylindrical in shape, the opening 42 may be formed at one end of the body 41, and a heat dissipation structure may be arranged at the other end of the body 42. The through hole 43 may be formed in the other end of the body 41. Specifically, the through hole 43 may be coaxial with the opening 42 and located in the middle of the heat dissipation structure, and the radial size of the through hole 43 may be less than the radial size of the opening 42. In some embodiments, positioning structures are arranged on the housing 40 and the rotor core 10. The positioning structures can prevent the housing 40 and the rotor core 10 from becoming separated from each other in case of a large torque and high speed. In some embodiments, the positioning structures may include a bulge 14 and a positioning groove 411, and the bulge 14 may be arranged on an outer wall surface of the rotor core 10. Specifically, the bulge 14 may be located on an outer wall surface of the cylindrical body 11. There can be provided with multiple such bulges 14 that are arranged at intervals in the circumferential direction of the rotor core 10 and may protrude from the outer wall surface of the rotor core 10 in the radial direction of the rotor core 10. The positioning groove 411 may be formed in an inner wall surface of the housing 40. Specifically, in some embodiments, the positioning groove 411 may be formed in an inner wall surface of the body 41. There can be provided with multiple such positioning grooves 411 that are arranged at intervals in the circumferential direction of the rotor core 10 and correspond to the bulges 14. When the housing 40 and the rotor core 10 are assembled together, the bulges 14 may be engaged in the positioning grooves 411, such that the housing 40 and the rotor core 10 are prevented from becoming separated from each other.

Further, in some embodiments, the rotor of the brushless motor may further include the rotary shaft 50. The rotary shaft 50 may be used to output power, and two ends of the rotary shaft 50 may extend out of the rotor core 10 via the opening 42 and the through hole 43, respectively.

Further, in some embodiments, the rotor of the brushless motor may further include an anti-slip sleeve 60. The anti-slip sleeve 60 may be arranged in the through hole 43 and sleeved around the rotary shaft 60 to prevent the rotary shaft 50 from falling off from the housing 40 or slipping under a high speed and large torque.

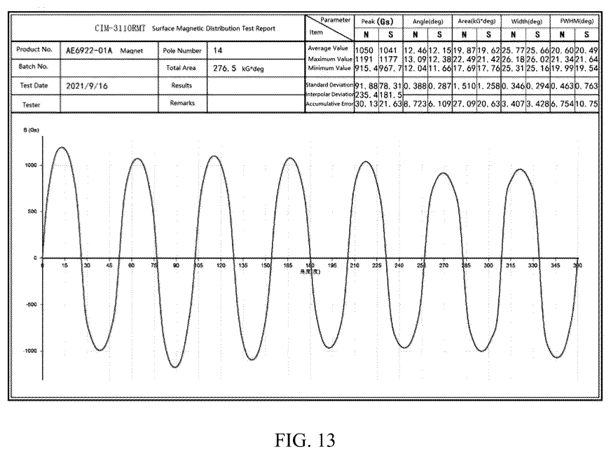

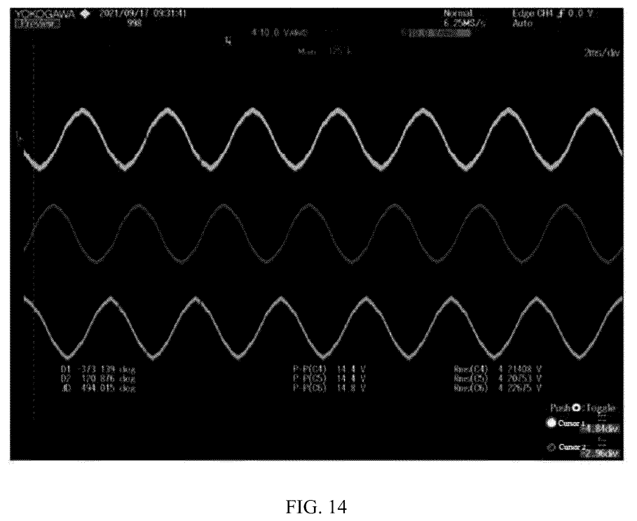

The magnetic field distribution of the brushless motor is shown in FIG. 12 and FIG. 13, and the counter electromotive force of the brushless motor is shown in FIG. 14. As can be seen, the magnetic field distribution of the brushless motor is uniform, and the counter electromotive force of the brushless motor has a good sinusoidal degree, and therefore the requirements of FOC drive can be satisfied.

It should be understood that the above embodiments are specifically described in detail to express several preferred implementations of the application, and should not be construed as limitations to the patent scope of the application. It should be pointed out that people with ordinary skill in the art can freely combine the above technical features and make some transformations and improvements without departing from the concept of the application, and all these combinations, transformations and improvements should fall within the protection scope of the application. Therefore, all equivalent transformations and modifications made according to the scope of the claims of the application should fall within the scope of the claims of the application.

1. A rotor of a brushless motor, comprising a rotor core (10), multiple first magnets (20) for generating first magnetic fields in a radial direction of the rotor core (10), and multiple second magnets (30) for generating second magnetic fields in a tangential direction of the rotor core (10), wherein the multiple first magnets (20) and the multiple second magnets (30) are alternately arranged one by one in a circumferential direction of the rotor core (10) so that the first magnetic fields and the second magnetic fields are mixed to form a hybrid magnetic field.

2. The rotor of a brushless motor according to claim 1,
wherein the first magnets (20) and the second magnets (30) are all bar shaped magnets;
each of the first magnets (20) has a first width direction and a first thickness direction perpendicular to the first width direction; the first width direction is perpendicular to the radial direction of the rotor core (10), and the first thickness direction is perpendicular to the tangential direction of the rotor core (10);
each of the second magnets (30) has a second width direction and a second thickness direction perpendicular to the second width direction;
the second width direction is perpendicular to the tangential direction of the rotor core (10), and the second thickens direction is perpendicular to the tangential direction of the rotor core (10).

3. The rotor of a brushless motor according to claim 1,
wherein the rotor core (10) is configured as a hollow structure with a hollow space extending through the two ends of the rotor core (10);
multiple first limiting slots (12) in one-to-one correspondence with the multiple first magnets (20) are formed in an inner wall surface of the rotor core (10).

4. The rotor of a brushless motor according to claim 3,
wherein multiple second limiting slots (13) in one-to-one correspondence with the multiple second magnets (30) are formed in the inner wall surface of the rotor core (10);
the multiple first limiting slots (12) and the multiple second limiting slots (13) are alternately arranged one by one in the circumferential direction of the rotor core (10).

5. The rotor of a brushless motor according to claim 1, wherein further comprising a housing (40) sleeved around an outside of the rotor core (10).

6. The rotor of a brushless motor according to claim 5,
wherein positioning structures are arranged on the housing (40) and the rotor core (10);
the positioning structures comprise a bulge (14) arranged on an outer wall surface of the rotor core (10) and protruding in the radial direction, and a positioning groove (411) formed in an inner wall surface of the housing (40) and corresponding to the bulge (14).

7. The rotor of a brushless motor according to claim 5, wherein further comprising a rotary shaft (50) with two ends extending out of the rotor core (10);
wherein the housing (40) comprises a body (41), an opening (42) formed at one end of the body (41) to allow for insertion of the rotor core (10) into the body (41), and a through hole (43) formed in the other end of the housing (41) to allow the rotary shaft (50) to extend out.

8. The rotor of a brushless motor according to claim 7,
wherein further comprising an anti-slip sleeve (60) arranged in the through hole (43) and sleeved around the rotary shaft (50).

9. The rotor of a brushless motor according to claim 7, wherein surfaces, facing each other, of two of the second magnets (30) located on two opposite sides of each of the first magnet (20) are identical in magnetic polarity;
surfaces, facing the rotary shaft (50), of two of the first magnets (20) located on two opposite sides of each of the second magnet (30) are opposite in magnetic polarity.

10. A brushless motor, comprising the rotor according to claim 1, and a stator assembled with the rotor.

11. The brushless motor according to claim 10, wherein the first magnets (20) and the second magnets (30) are all bar shaped magnets;
each of the first magnets (20) has a first width direction and a first thickness direction perpendicular to the first width direction; the first width direction is perpendicular to the radial direction of the rotor core (10), and the first thickness direction is perpendicular to the tangential direction of the rotor core (10);
each of the second magnets (30) has a second width direction and a second thickness direction perpendicular to the second width direction;
the second width direction is perpendicular to the tangential direction of the rotor core (10), and the second thickens direction is perpendicular to the tangential direction of the rotor core (10).

12. The brushless motor according to claim 10, wherein the rotor core (10) is configured as a hollow structure with a hollow space extending through the two ends of the rotor core (10);
multiple first limiting slots (12) in one-to-one correspondence with the multiple first magnets (20) are formed in an inner wall surface of the rotor core (10).

13. The brushless motor according to claim 12, wherein multiple second limiting slots (13) in one-to-one correspondence with the multiple second magnets (30) are formed in the inner wall surface of the rotor core (10);
the multiple first limiting slots (12) and the multiple second limiting slots (13) are alternately arranged one by one in the circumferential direction of the rotor core (10).

14. The brushless motor according to claim 10, wherein further comprising a housing (40) sleeved around an outside of the rotor core (10).

15. The brushless motor according to claim 10, wherein positioning structures are arranged on the housing (40) and the rotor core (10);
the positioning structures comprise a bulge (14) arranged on an outer wall surface of the rotor core (10) and protruding in the radial direction, and a positioning groove (411) formed in an inner wall surface of the housing (40) and corresponding to the bulge (14).

16. The brushless motor according to claim 15, wherein further comprising a rotary shaft (50) with two ends extending out of the rotor core (10);
wherein the housing (40) comprises a body (41), an opening (42) formed at one end of the body (41) to allow for insertion of the rotor core (10) into the body (41), and a through hole (43) formed in the other end of the housing (41) to allow the rotary shaft (50) to extend out.

17. The brushless motor according to claim 15, wherein further comprising an anti-slip sleeve (60) arranged in the through hole (43) and sleeved around the rotary shaft (50).

18. The brushless motor according to claim 17, wherein surfaces, facing each other, of two of the second magnets (30) located on two opposite sides of each of the first magnet (20) are identical in magnetic polarity;
surfaces, facing the rotary shaft (50), of two of the first magnets (20) located on two opposite sides of each of the second magnet (30) are opposite in magnetic polarity.
